(19) United States
(12) Patent Application Publication
(10) Pub. No.: US 2007/0280646 A1
(43) Pub. Date: Dec. 6, 2007

(54) Method and apparatus transmitting audio signals and video signals

(75) Inventors: Takahiro Seita, Mitaka-shi (JP); Hideki Saito, Fussa-shi (JP); Shuichi Hisatomi, Fuchu-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,202

(22) Filed: May 30, 2007

(30) Foreign Application Priority Data
May 31, 2006 (JP) 2006-152707

(51) Int. Cl. H04N 7/00

(52) U.S. Cl. 386/96

(57) ABSTRACT

According to one embodiment, an audio/video signal transmitting device includes a hot plug detection unit that acquires from a first audio and video reproduction device and a second audio and video reproduction device, formats of audio/video data that can be reproduced by each of the reproduction devices, a setting processing unit that extract a common format of the acquired formats of the audio/video data that can be reproduced by each of the reproduction devices, and an output signal processing unit that supplies the audio/video data to be reproduced to the first and second audio and video reproduction devices in accordance with the extracted common format.

### CROSS-REFERENCE TO RELATED APPLICATIONS

This application is based upon and claims the benefit of priority from Japanese Patent Application No. 2006-152707, filed May 31, 2006, the entire contents of which are incorporated herein by reference.

### BACKGROUND

1. Field

One embodiment of the invention relates to an apparatus of transmitting audio and video signals, in which output specifications of a resolution (video specification) and an audio format (audio specification) can be commonly set by obtaining necessary information retained by a plurality of devices that reproduce audio data and video data respectively when they are connected to each other via a bi-directional communication interface.

2. Description of the Related Art

Image data reproducing devices to which a plurality of devices that reproduce audio and video data can be connected via an interactive communication interface, that is, for example, digital video recorder, are now very popular.

In such a device, a digital video recorder that is now connected, a device newly connected or a device that is disconnected are detected one by one by the hot plug detection method.

For example, Japanese Patent Application Publication (KOKAI) No. 2001-356752 a splitter device that detects each device connected thereto and outputs an image signal in the format in compliance with each respective device.

However, even with the structure presented in the Publication No. 2001-356752, it is not possible to detect the audio format for reproducing audio data. Further, such a technique that an arbitrary device is specified out of a plurality of devices connected, and a higher priority is given to a format that can be reproduced by the specified device, has not been automated even today.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a data reproduction device (video signal transmission device) according to an embodiment of the invention;

FIG. 2 is an exemplary diagram showing an example of file data in a standard that defines video and audio formats that can be acquired/extracted by the video signal transmission device (data reproduction device) shown in FIG. 1;

FIG. 3 is an exemplary flowchart showing examples of a method of acquiring/extracting video and audio formats that can be reproduced by a device connected to the video signal transmission device shown in FIG. 1;

FIG. 4 is an exemplary diagram showing examples of specifications of video signal transmission device shown in FIG. 1, acquired as a video format that can be reproduced by a device connected thereto according to an embodiment of the invention; and

FIG. 5 is an exemplary diagram showing examples of specifications of video signal transmission device shown in FIG. 1, acquired as an audio format that can be reproduced by a device connected thereto according to an embodiment of the invention.

### DETAILED DESCRIPTION

Various embodiments according to the invention will be described hereinafter with reference to the accompanying drawings. In general, according to one embodiment of the invention, an audio/video signal transmitting device includes a hot plug detection unit that acquires from a first audio and video reproduction device and a second audio and video reproduction device, formats of audio/video data that can be reproduced by each of the reproduction devices; a setting processing unit that extract a common format of the acquired formats of the audio/video data that can be reproduced by each of the reproduction devices; and an output signal processing unit that supplies the audio/video data to be reproduced to the first and second audio and video reproduction devices in accordance with the extracted common format.

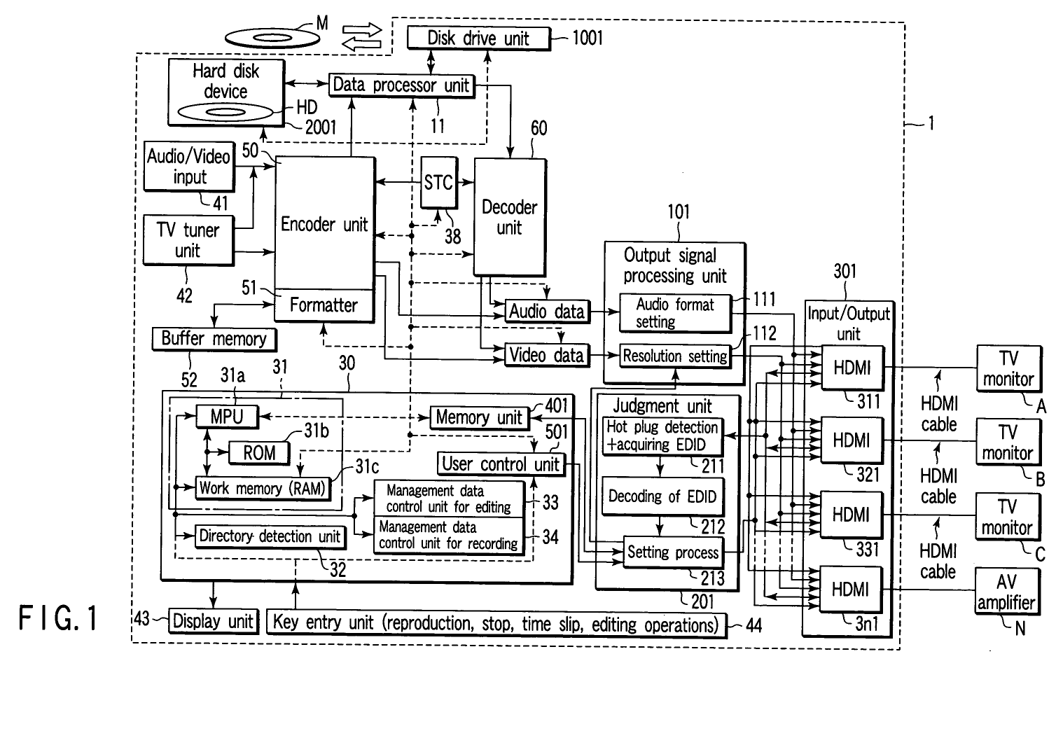

According to an embodiment, FIG. 1 shows an example of a video/audio signal reproduction device according to the present invention is applicable to, for example, a personal computer (PC) and naturally, data to be stored on a recording medium may be, for example, document data an embodiment of the invention. Further, the video/audio signal reproduction device provides a TV monitor connected with the function of the signal transfer device (transmission device), and therefore in some case, it is called a video/audio signal transmission device.

FIG. 1 is a brief block diagram of a video/audio signal reproduction device (video recorder) including a plurality of HDMI output terminals.

The video/audio signal reproduction device 1 shown in FIG. 1 includes a disk drive unit 1001 that can construct video files on an optical disk M of, for example, DVD standard. It is only natural that the optical disk M may be of, for example, CD standard, or even HD (high-definition) DVD standard or Blu-Ray standard, which has a larger recording capacity as compared to the optical disk of the current DVD standard.

Although it will not be described in detail, the disk drive unit 1001 includes a rotation control system that rotates an optical disk M at a predetermined speed, a laser drive system that irradiates laser light of a predetermined wavelength onto an optical disk M in order to record data in the recording surface of the disk or reproduce data recorded on the disk M, a laser optical system that guides the laser light, etc.

The video recorder 1 can construct video files similarly in a hard disk HG housed in a hard disk device (to be called as HDD hereinafter) 2001.

Data to be recorded (recording data) on the optical disk M loaded on the disk drive 1001 or the hard disk HD of the HDD 2001 is recorded on a recording medium (designated in advance) (that is, the optical disk M or hard disk HD) under the control of a data processor unit 11. Meanwhile, data recorded in the optical disk M of the disk drive unit 1001 or the hard disk HD of the HDD 2001 are read therefrom under the control of the data processor unit 11 (that is, reproduction data are read).

The data processor unit 11 handles recording data or reproduction data in a predetermined unit, and it includes a buffer circuit, modulation and demodulation circuits, an error correction unit, etc.

The video recorder 1 includes as its main parts an encoder unit 50 serving as a data processing unit that records input data, a decoder unit 60 serving as a data processing unit that reproduces data that are already recorded, and a micro-computer block 30 that controls the operation of the video recorder 1.

The encoder unit 50 includes video and audio analog-digital converters that digitalize an analog video signal and an analog audio signal that are inputted thereto, respectively, a video encoder and an audio encoder. The encoder unit 50 further includes a sub video encoder.

An output from the encoder unit 50 is converted into a predetermined DVD-RAM format in a formatter 51 that includes a buffer memory, and then supplied to the data processor unit 11 described above.

The encoder unit 50 receives an external analog video signal and an external analog audio signal from an AV input unit 41 or an analog video signal and an analog audio signal from a TV tuner unit 42.

When a compressed digital video signal or digital audio signal is input directly to the encoder 50, the compressed digital video signal or digital audio signal can be supplied directly to the formatter 51. In addition, the encoder unit 50 can supply an analog-digital converted digital video signal or digital audio signal to a video mixing unit 71 or an audio selector 76.

Although it is not illustrated in the figure, the encoder unit 50 includes a video encoder, where a digital video signal is converted into a compressed digital video signal at a variable bit rate based on, for example, MPEG2 or MPEG1 standard. On the other hand, a digital audio signal is converted into a digital audio signal compressed at a fixed bit rate based on, for example, MPEG or AC-3 standard, or a (non-compressed) digital audio signal such as linear PCM.

When a sub video signal (for example, a signal from a video player equipped with an independent output terminal for the sub video signals) is input directly through from the AV (audio/video) input unit 41, or a broadcast signal of a DVD video signal having an equivalent data structure is received by the TV tuner unit 42, the sub video signal in the DVD video signal is encoded (run-length coded) by the sub video encoder and thus a bit map of the sub video (that is, sub video data) is constructed.

The encoded digital video signal and digital audio signal and the sub video data are packed by the formatter 51 into a video pack, an audio pack and a sub video pack. The vide pack, audio pack and sub video pack are further grouped (aggregated), and then converted into a format specified by the DVD-video standard (DVD video format) or a format specified by the DVD-recording standard (DVD VR format).

The data formatted by the formatter 51 (that is, the packs of the video, audio and sub video data, etc.) and management information (file system) formed by an MPU (CPU) 31a (, which will be presented later) are supplied to the HDD 2001 or disk drive unit 1001 via the data processor unit 11, where the data are recorded on the hard disk HD or an optical disk M, respectively. It should be noted that the data recorded on the hard disk HD or the optical disk M can be replaced with each other or copied via the data processor unit 11. In other words, the data already recorded on the hard disk HD can be moved to or copied onto the optical disk M, and the data recorded on the recorded on the optical disk M can be moved to or copied onto the hard disk HD, as well.

Further, the data recorded on the hard disk HD or optical disk M, that is, for example, a video object of a program can be edited in such a way that a portion of or whole program is deleted, or an arbitrary number of objects are synthesized (connected).

It should be noted that the formatter 51 of the encoder unit 50 forms various types of data segments while recording data (video recording), which are sent to the MPU (CPU) 31a of the micro-computer block 30 periodically (data of timing of interrupt to the head of GOP, etc.). Examples of the data segments are the number of packs of VOBU, the end address of I picture from the head of VOBU, the reproduction time of VOBU, etc.

The formatter 51 supplies to the MPU (CPU) 31a, for example, aspect ratio data from an aspect data processing unit, when recording is started. Based on the data supplied, the MPU (CPU) 31a forms VOB stream data (STI). The STI contains resolution data, aspect data, etc., and the reproduction, each of the decoder unit is initialized based on the STI data.

The data processor unit 11 receives data by unit of VOBU from the formatter 51 of the encoder unit 50, and supplies data by unit of CDA to the disk drive unit 1001 or HDD 2001. Meanwhile, the MPU (CPU) 31a of the microcomputer block 30 forms management information necessary to reproduce the recorded data, and when the MPU 31a recognizes a data recording end command, which indicates that the recording of data is finished, it sends the formed management information to the data processor unit 11.

In this manner, the management information is recorded on the recording medium (the optical disk M or hard disk HD). In order to start the recording of data, the MPU (CPU) 31a reads the management information from the optical disk M or hard disk HD and recognizes the blank area of the respective disk and sets the data recording area to the respective disk via the data processor unit 11.

The microcomputer block 30 includes a main control unit 31 containing, for example, an MPU (micro-processing unit) or CPU (central processing unit) 31a, a ROM (read only memory) 31b that holds a control program, etc., which operates various elements of the data recording/reproduction device 1 and control blocks, etc., and a RAM (random access memory) 31c that provides a predetermined work area for executing a program.

In the microcomputer block 30, the RAM 31c is used as the work area to execute the detection of an error site, detection of an unrecorded area, setting of recording site of video recording data, UDF recording, setting of an AV address, or the like.

The microcomputer block 30 includes a directory detection unit 32, and further, a VMG data (entire video management information) forming unit, a copy (duplication)-related data detection unit, a copy (duplication)/scrambling data processing unit (RDI processing unit), a packet header processing unit, a sequence header processing unit and an aspect ratio data processing unit. The microcomputer block 30 includes a recording management information control unit (to be called as video recording management control unit) 33 operated when video recording of data is executed, and an editing management information control unit (to be called as editing management control unit) 34 operated when editing of already recorded data is executed. A characterizing embodiment of the present invention is executed in the control unit 34 for management information when the editing is carried out and in the control unit 33 for management information when the video recording is carried out.

The results executed by the MPU (CPU) 31a, the contents to be notified to the user are displayed on the display unit 43 of the data recording/reproduction device 1 or OSD-displayed on a monitor (to be connected as an external device, which will be described later).

Further, the microcomputer block 30 includes a key entry unit 44 used to input a control signal from the user to operate the device 1, that is, an operation signal (to the microcomputer block 30). The key entry unit 44 is equivalent to operation switches provided at arbitrary positions of the recording/reproduction device, or, although not shown in the figure, a remote control device that can input an operation signal via a remote control signal receiving unit also not shown. The key entry unit 44 input may be a personal computer that can input a control signal to the recording/reproduction device 1 via wire, radio or optical means (including infrared ray means), etc. That is, regardless of the form of the key entry unit 44, the user operations the key entry unit 44 in order to execute the recording of video and audio signals input, reproduction of recorded contents, editing of the recorded contents, etc.

When the microcomputer block 30 controls the disk drive unit 1001, HDD 2001, data processor unit 11, encoder unit 50, decoder unit 60, etc. and the timings for controlling these members are based on the time data from an STC (system time clock) 38. The operation of recording or reproduction is executed usually in synchronism with a time clock from the STC 38. As to the other processes, they may be executed at independent timings from that of the STC 38.

The decoder unit 60 includes a video processor that synthesizes a decoded sub video with a decoded main image at a predetermined timing, and outputs an image in which a menu, highlights, subtitles (presentation of speeches in words), or other sub videos are superimposed (on a main image). Although it will not be described in detail, the decode unit 60 includes a separator that separates and extracts packs from a signal of a DVD format that has a pack structure, a memory used for separation of packs from each other and for some signal processing, a video decoder that decodes main video data (the contents of the video pack) separated by the separator, a sub video pack decoder that decodes sub video data (the contents of the sub video pack) separated by the separator, and an audio decoder that decodes audio data (the contents of the audio pack) separated by the separator.

An output signal processing device 101 is connected to the decode unit 60, and as will be described later in detail, the output signal processing device 101 sets an output format used to output the decoded audio data and video data to an arbitrary number of output devices (such as a sink device and repeater device) connected to the device 1 via an input/output unit 301 described later. It should be noted that the sink device and repeater device are devices of general names that can detect whether or not a respective device is plugged in by the “hot plug detection in, for example, the HDMI (interface) standard or DVI (interface) standard. A TV monitor device (television receiver) and a video/image display device belong to the sink device, whereas an AV (audio-video) amplifier, a memory device of a personal computer used as a server, etc. belong to the repeater devices.

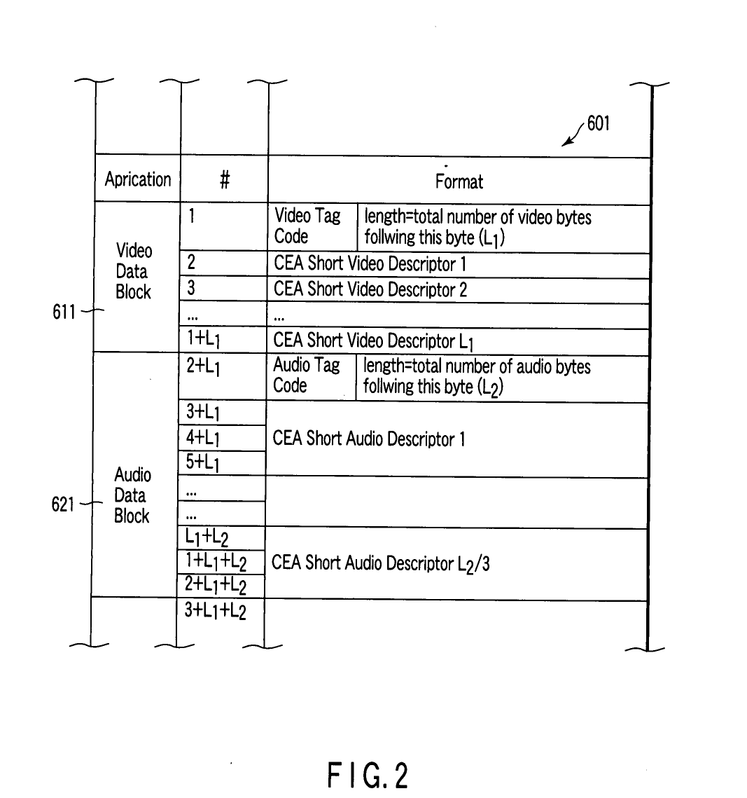

The output signal processing unit 101 includes an audio format setting unit that acquires (extracts) the “audio format data” from the decoded audio data, and a resolution setting unit 112 that acquires (extracts) the “resolution data” from the decoded video data. As will be explained later with reference to FIG. 2, audio format codes and video identification codes are acquired respectively from an “audio data block” 621 and a “video data block” 611 recorded in a predetermined region of file data 601 specified in conformity with, for example, EIA/CEA-861B.

A detection/judgment unit 201 that detects whether or not a device is plugged in by the “hot plug detection” is connected to the output signal processing unit 101. The detection/judgment unit 201 includes a hot plug detection unit 211 that detects that a device that can be detected by the “hot plug detection” has been connected or such a device is already connected, an EDID decode unit 212 that decodes individual identification data unique to individual output devices, acquired from an arbitrary number of devices detected by the hot plug detection unit 211 (that is, EDID (extended display identification data), and a setting processing unit 213 that sets the format of audio data and the resolution of video data to be output to the input/output unit 301 based on the result obtained by decoding with the EDID decode unit 212, that is, the acquired EDID data.

It should be noted that the input/output unit 301 connected to the output signal processing unit 101 a predetermined number of HDMI terminals (transmitters) 311, 321, . . . 3n1 (n is a natural number) that can supply audio data and video data whose audio format and resolution are respectively set, to a predetermined number of output devices (detected by the “hot plug detection”). To the HDMI terminals 311, 321, . . . , 3n1, connected arbitrarily are, for example, a TV monitor device A, a TV monitor device B, a TV monitor device C, . . . , a (hot-plug detectable) repeater (AV amplifier) N. etc. via HDMI cables 1, 2, . . . , n (n is a natural number).

When each of the sink devices and repeater devices HDMI-connected to the above-described video/audio signal transmitting device 1, such as the TV monitor device A, TV monitor device B, TV monitor device C, . . . , (hot-plug detectable) repeater (AV amplifier) N, is detected by the “hot plug detection” by the detection/judgment unit 201 (hot plug detection unit 211), EDID of the detected sink devices and repeater devices are acquired. Each detected EDID is decoded by the EDID decoding unit 211 and thus the data of the respective sink device or repeater device is acquired. Examples of the data obtained by the decoding are not only types (audio data) of audio formats that can be reproduced by a sing device or repeater device (as an audio output) and a resolution (video data) that can be displayed by a sink device or repeater device (as a video output), but also Manufacture ID, Product ID and Serial Number.

When at least the above-described audio format and resolution of the HDMI-connected sink devices or repeater devices are detected by the “hot plug detection” with the detection/judgment unit 201, the audio data (format) and video data (resolution) output from the device 1 (generally referred to as a source device in relation to the sink devices and repeater devices) are compared with each other, and thus it is checked whether or not there is any format or resolution that is common to all the sink devices or repeater devices.

For example, when an audio format which each sink device or repeater device checked can handle contains at least “linear PMC” as shown in FIG. 5, the setting processing unit 213 sets (instructs) “audio format → [linear PCM]” to the output signal processing unit 101. As will be described later in detail, when, for example, “DTS” is selected by the switch instruction made by the user, the audio data cannot be correctly reproduced by the TV monitor device A and TV monitor device B.

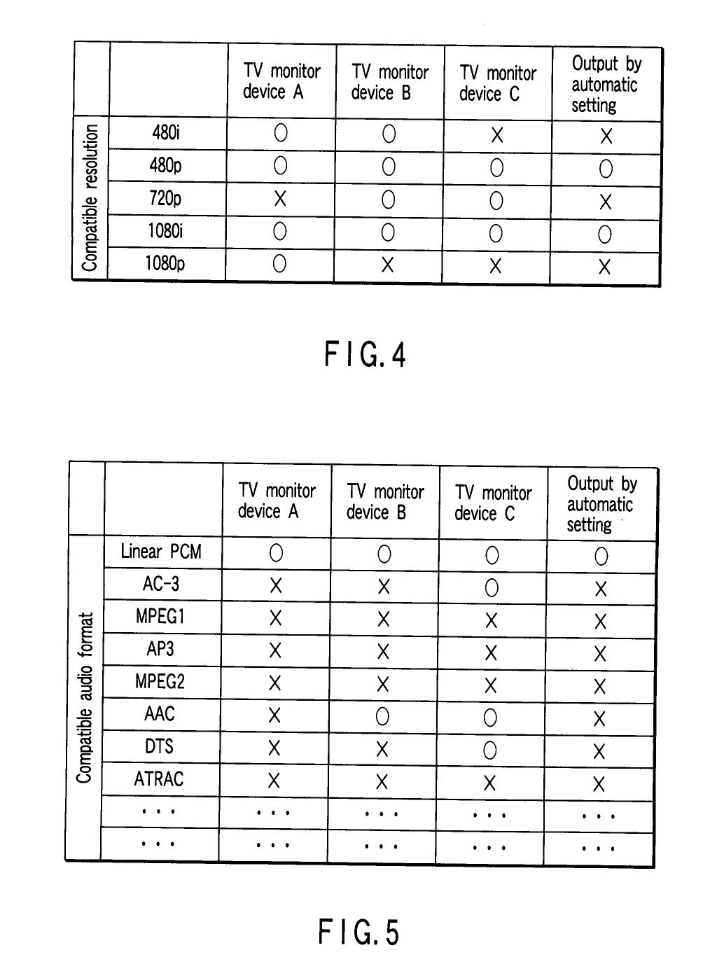

For example, when a video output (resolution) which each sink device or repeater device checked cab handle contains at least “480p (525p)” or “1080i (1125i)” as shown in FIG. 4, the setting processing unit 213 sets (instructs) a high resolution “output resolution → [1080i (1125i)]” to the output signal processing unit 101. As will be described later in detail, when, for example, “DTS” is selected by the switch instruction made by the user, the audio data cannot be correctly reproduced by the TV monitor device A and TV monitor device B. It should be noted that the set value can be changed to “480p (525p)” if the user makes such a switching instruction, as will be described later. However, when “1080i (1125i)” is selected by the user, appropriate video images are not displayed on the TV monitor B or TV monitor C.

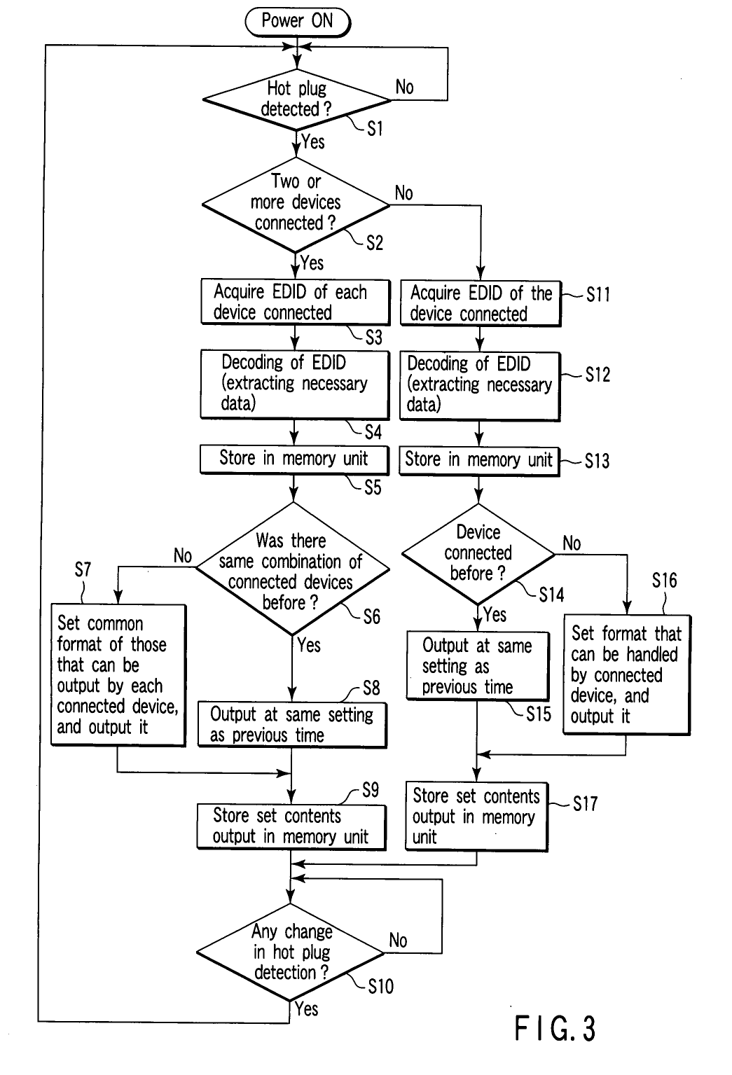

In more detail, FIG. 3 shows processing steps for setting audio formats (audio data) and resolutions (video data) to be output to an arbitrary number of sink devices or repeat devices connected to the video/audio signal transmitting device equipped with a plurality of HDMI output terminals, to be hot-plug detectable.

That is, when the source device (video/audio signal transmitting device 1) is started, the presence/absence of sink devices or repeater devices HDMI-connected to the input/output unit 301 is detected by the hot plug detection (S1), and when two or more sink devices or repeater devices are detected (S2-Yes), the EDID of each device detected is acquired by the hot plug detection unit 211 (detection/judgment unit 201) (S3).

The acquired EDID is decoded by the EDID decode unit 212. Then, at least the reproducible audio format (audio data) and resolution (video data) are extracted (acquired) as necessary data from the decoded EDID. Further, as necessary date, Manufacture ID, Product ID and Serial Number are acquired (extracted) as well (S4).

The necessary date obtained in step S4, which contain the audio format (audio data) and resolution (video data) are stored in, for example, a non-volatile memory (NVRAM) of the memory unit 401 of the video/audio signal transmitting device 1.

From the data extracted from each connected device in step S4 and stored in the memory unit in step S5, it is confirmed (checked) whether or not there was the same combination of an arbitrary number of devices connected before (S6).

In step S6, when it is confirmed (checked) that the combination of the connected devices is new (that is, no such a combination before) (S6-No), the applicable format common to each connected device, that is, the resolution (Video) and audio format (audio) are extracted and then output (S7). On the other hand, it is detected (confirmed) that there was such a combination (existed) of the connected devices in step S6 (S6-Yes), the same set value as that previous combination is output (S8). In this manner, video software (contents) can be monitored with a plurality of monitor devices at the same time using one source device with HDMI terminals without repeater devices. Further, the user is able to monitor the video and audio contents without having to care about the video specification (resolution) or audio output mode (audio format) that can be handled by a plurality of sink devices.

It should be noted that the combination newly recognized in step S7 and the combination maintained in step 6 (S6-Yes) and step S8, that is, the video specification (resolution) and audio output mode (audio format) are stored in the memory unit 401 (S9). From that point, whether or not the “hot plug detection” of the transmitting device 1 having HDMI terminals is changed, that is, whether a new hot-plug detectable device has been connected or an already connected hot plug detectable device has been disconnected, is monitored (S10) at all times. When a change is detected, the necessary data are once again extracted from step S1 in the order, and thus the video specification (resolution) and audio output mode (audio format) are set.

Further, as described above, in step S9, the final output (transmission) setting and the decoding results of the EDID (video data, etc. of each sink device) are retained in the memory unit 401. In this manner, when the set (device 1) is started next time, the previous setting can be used directly as it is when the same devices are connected.

It should be noted that with regard to the “output resolution (video specification)” output to the output signal processing unit 101, at least “480p (525p)” and “1080i (1125i)” can be selected as shown in FIG. 4, and therefore the setting can be changed (switched) to either one of them under the control of the user control unit 501 corresponding to the selection instruction (entry) from the key input unit 44 by the user.

On the other hand, in step S2, when it is detected by the “hot plug detection” that there is only one sink device or repeater device connected (S2-No), the EDID of the only one device whose connection is detected is extracted (S11) by the hot plug detection unit 211. Then the extracted EDID is decoded (S12) and then stored in the memory unit 401 (S13).

The data stored in the memory unit in step S13 are checked as to whether or not the device is an HDMI device that has been connected before (S14).

When it is confirmed in step S14 that the device has not been connected before (S14-No), the common formats that can be handled by the device, that is, the resolution (video) and audio format (audio) are extracted and output (S15). On the other hand, when it is detected in step S14 that the connected device is a device that has been connected (S14-Yes), the same setting (set value) as that of the previous time is output (S15).

In this manner, only by connecting a sink device such as a TV monitor device to a source device equipped with HDMI terminals, the video output specification (resolution) and audio output mode (audio format) appropriate for reproducing video software (or contents) are automatically set. It should be noted that when there is only one device connected by HDMI, it is naturally that the “output resolution (video specification)” and “audio format (audio output specification)” to be output to the output signal processing unit 101 can be changed (switched) arbitrarily under the control of the user control unit 501 corresponding to the selection instruction (entry) from the key input unit 44 by the user.

It should be noted that the setting for the transmission to the devices detected in step S16 and the setting for the transmission maintained in steps S14 and S15, that is, the video output specification (resolution) and audio output mode (audio format) are stored in the memory unit 401 (S17).

From that point, whether or not the “hot plug detection” of the transmitting device 1 having HDMI terminals is changed, that is, whether a new hot-plug detectable device has been connected or an already connected hot plug detectable device has been disconnected, is monitored (S10) at all times. When a change is detected, the necessary data are once again extracted from step S1 in the order, and thus the video specification (resolution) and audio output mode (audio format) are set.

It should be noted that the connection or disconnection of a device that can be detected by the hot plug detection or whether or not the switching instruction is input by the user is monitored at all times in step S10 (and the repeating routine from step S1), and when it is detected that an instruction of selecting the TV monitor device 1 (as a sink device to serve as an output device) has been input by the user, the output resolution is switched automatically to “1080p (1125p)” in examples shown in FIG. 4.

Further, as described above, in step S17, the final output (transmission) setting and the decoding results of the EDID (video data, etc. of each sink device) are retained in the memory unit 401. In this manner, when the set (device 1) is started next time, the previous setting can be used directly as it is when the same devices are connected.

FIG. 4 shows examples of resolutions actually set from the resolution data which can be handled by each respective sink device.

As shown in FIG. 4, when the TV monitor device A that can handle the resolution of “480i”, “480p”, “1080i” or “1080p”, the TV monitor device B that can handle the resolution of “480i”, “480p”, “720i” or “1080p” and the TV monitor device C that can handle the resolution of “480p”, “720p” or “1080i” are connected, the common resolution that can be handled by the three monitors is “480p” or “1080i”, and therefore a higher resolution “1080i (1125i)” is selected in a normal automatic setting mode.

FIG. 5 shows examples of audio formats actually set from the audio format data which can be handled by each respective sink device.

As shown in FIG. 5, when the TV monitor device A that can handle the audio output specification of “linear PCM” only, the TV monitor device B that can handle the audio output specifications of “linear PCM” and “AAC (Advanced Audio Coding)” and the TV monitor device C that can handle the audio output specifications of “linear PCM”, “AC-3 (Audio Code number 3)”, “AAC” and “DTS (Digital Theater System) are connected, the common audio format that can be handled by the three monitors is “linear PCM”, and therefore an audio format “linear PCM” is selected in a normal automatic setting mode. It should be noted that when the user selects, for example, “DTS”, the audio data cannot be properly reproduced by the TV monitor A or monitor B.

As described above, according to the present invention, when there are a plurality of sink devices HDMI-connected to the source device, the common output specifications of the resolution (video specification) and audio format (audio specification) to the sink devices are automatically set based on the EDID of the connected devices.

Further, according to the present invention, when there are a plurality of sink devices HDMI-connected to the source device and the output specifications of only particular sink devices should be set, the states in which the output specifications of only the devices that are desired to set is recognized by the source device. In this manner, the higher levels of the video specification (resolution) and audio specification (audio format) of the connected sink devices are automatically set.

For example, when the displayable video specifications of the three sets of TV monitor devices A, B and C shown in FIG. 1 include “480p (525p)” and “1080i (1125i)”, and that of the TV monitor device A includes “1080i (1125i)” as shown in FIG. 4, the TV monitor device A should be selected. In this manner, “1080i (1125i)” is selected as the video specification. Similarly, when the reproducible audio formats of the three sets of TV monitor devices A, B and C include “linear PCM” as shown in FIG. 5, the TV monitor device B and device C should be selected. In this manner, “linear PCM” or “AAC” can be selected as the audio format. On the other hand, when only the TV monitor device C is selected, “AC-3” or “DTS” can be selected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio and video signal transmitting device comprising:
an acquiring unit that acquires, from a first audio and video reproduction device that can reproduce audio data and video data at an arbitrary format and a second audio and video reproduction device that can reproduce audio data and video data at an arbitrary format, the formats of the audio data and video data that can be reproduced by each of the reproduction devices;
an extraction unit that a common format of the formats of the audio data and video data that can be reproduced by each of the reproduction devices, acquired by the acquiring unit; and
a supply unit that supplies the audio data and video data to be reproduced to the first audio and video reproduction device and the second audio and video reproduction device in accordance with the common format extracted by the extraction unit.

2. The audio and video signal transmitting device according to claim 1, wherein the acquiring unit, the extraction unit and the supply unit are connected to the first and second audio and video reproduction devices via a bi-directional communication interface (HDMI interface) of a predetermined standard.

3. The audio and video signal transmitting device according to claim 2, wherein the bi-directional communication interface includes an HDMI interface.

4. The audio and video signal transmitting device according to claim 1, wherein output specifications to be instructed to the first and second audio and video reproduction devices via the acquiring unit, the extraction unit and the supply unit are an audio format and a resolution.

5. The audio and video signal transmitting device according to claim 1, further comprising:
a memory unit that stores data of the first and second audio and video reproduction devices obtained by the acquiring unit and the extraction unit, and the formats of the audio data and video data to be supplied from the supply unit to the first and second audio and video reproduction devices.

6. The audio and video signal transmitting device according to claim 5, wherein when the data of the first and second audio and video reproduction devices obtained by the acquiring unit and the extraction unit coincide with the data stored in the memory unit, the audio data and video data of the formats stored in the memory unit are supplied to the first and second audio and video reproduction devices.

7. A signal processing method for an audio and video signal transmitting device, comprising:
acquiring an audio format (specification) and a video format (specification) that can be reproduced by a first audio and video reproduction device that can reproduce audio data and video data at an arbitrary format;
acquiring an audio format (specification) and a video format (specification) that can be reproduced by a second audio and video reproduction device that can reproduce audio data and video data at an arbitrary format;
extracting a common format of the audio format and video format that can be reproduced by each of the reproduction devices;
supplying the audio data and video data to be reproduced to each of the reproduction devices in accordance with the common format extracted; and
retaining the formats of the audio data and video data supplied.

8. The signal processing method according to claim 7, wherein when the extracted common format is already retained, the audio data and video data of the retained format are supplied to each of the reproduction devices.

9. The signal processing method according to claim 7, wherein when one of the audio and video reproduction devices is selected, the audio data and video data of the format of the highest level that can be reproduced by the selected device are supplied thereto.
